(19) United States
(12) Patent Application Publication
(10) Pub. No.: US 2009/0207098 A1
(43) Pub. Date: Aug. 20, 2009

(54) PORTABLE ELECTRONIC DEVICE AND DISPLAYING METHOD THEREOF

(75) Inventors: Yih-Long Tseng, Tainan County (TW); Yung-Yuan Ho, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/040,121

(22) Filed: Feb. 29, 2008

Related U.S. Application Data
(60) Provisional application No. 60/947,990, filed on Jul. 5, 2007.

(51) Int. Cl. G09G 5/00

(52) U.S. Cl. 345/3.2

(57) ABSTRACT

A portable electronic device capable of displaying high resolution image is provided. The portable electronic device includes: a processor for providing a first video signal and a second video signal, wherein the first video signal is for displaying control options for selection, and the second video signal is generated according to a selected one of the control options; a display panel for displaying a first image with the control options according to the first video signal; a frame rate converter (FRC) for converting the second video signal into a third video signal; and a projector, independent of said display panel, for projecting a second image according to the third video signal, wherein the second image being controlled by the control options displayed on the display panel.

### CROSS-REFERENCE TO RELATED APPLICATION

This application claims the priority benefit of U.S.A. provisional application Ser. No. 60/947,990, filed on Jul. 5, 2007. The entirety of the above-mentioned patent application is hereby incorporated by reference herein and made a part of this specification.

### BACKGROUND OF THE INVENTION

1. Field of Invention

The present invention relates to a portable electronic device and a display method thereof, for displaying high resolution images.

2. Description of Related Art

These days, the use of portable electronic devices has rapidly increased since they have a compact size and are convenient to use. As the panel of portable electronic devices, a display such as an FPD (flat panel display) is adopted in view of its improved portability.

Along with the advancement of mobile communication technology, a personal mobile communication device such as a mobile phone has evolved into a multi-functional, intelligent, sophisticated and versatile device. There is an increasing trend to market versatile mobile communication devices capable of not only performing voice communication, but also providing new multimedia-based information services related to games, video-on-demand, an electronic dictionary, an MP3, a variety of data and moving images.

Such versatile mobile communication devices incorporate a variety of collateral functions in a single unit and arouse a growing interest in consumers due to their convenience of use, functionality and design. As an example of a versatile mobile communication device, a horizontally viewed device has been developed in order to accommodate improved multimedia functions and address the increasing demand for moving image information services. Such state-of-the-art mobile communication devices are designed and produced in due consideration of what is called a form factor to thereby attain great improvement in design and functionality.

However, the display panel of portable electronic devices is usually not large in size, which means the display resolution is also limited. When high resolution images are displayed on the display panel of the state-of-art portable electronic devices, usually, only a portion of the image frame is displayed on the display panel at the same time, rather than the whole image frame is displayed at the same time.

FIG. 1 shows a diagram of high resolution image display on the state-of-art portable devices. As shown in FIG. 1, assume a high resolution image frame 110, for example have a resolution of 640*480 while the state-of-art portable device 100 has a display panel of resolution of 320*240. In display of the high resolution image frame 110, only a part of the high resolution image frame 110 is displayed on the device 100 at the same time. Part A of the high resolution image frame 110, which has a resolution of 320*240, is displayed on the device 100, then part B, part C and part D. In other words, user may feel inconvenient when he/she views high resolution image frame on portable electronic device with a low resolution display panel.

Therefore, there is a need for portable electronic devices capable of providing high resolution image display conveniently and easily.

### SUMMARY OF THE INVENTION

The invention provides a portable electronic device and a display method thereof, which is capable of displaying high resolution content images on a display panel while displaying control images on another display panel.

One example of the invention is to provide a portable electronic device, comprising: a processor for providing a first video signal and a second video signal, wherein the first video signal is for displaying control options for selection, and the second video signal is generated according to a selected one of the control options; a display panel for displaying a first image with the control options according to the first video signal; a frame rate converter (FRC) for converting the second video signal into a third video signal; and a projector, independent of said display panel, for projecting a second image according to the third video signal, wherein the second image being controlled by the control options displayed on the display panel.

Another example of the invention is to provide a display method, suitable for a portable electronic device, the method comprising: providing a first video signal and a second video signal, wherein the first video signal is for displaying control options for selection, and the second video signal is generated according to a selected one of the control options; displaying a first image with the control options according to the first video signal; converting the second video signal into a third video signal; and projecting the second image according to the third video signal, wherein the second image being controlled by the control options.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a diagram of high resolution image display on the state-of-art portable devices.

FIG. 2 shows a diagram of a portable electronic device according to a first embodiment of the invention.

FIG. 3a shows a simplified block diagram of the portable electronic device 200 according to a first example of the first embodiment of the invention.

FIG. 3b shows a simplified block diagram of the portable electronic device 200 according to a second example of the first embodiment of the invention.

FIG. 4 shows a diagram of a portable electronic device according to a second embodiment of the invention.

FIG. 5a shows a simplified block diagram of the portable electronic device 400 according to a first example of the second embodiment of the invention.

FIG. 5b shows a simplified block diagram of the portable electronic device 400 according to a second example of the second embodiment of the invention.

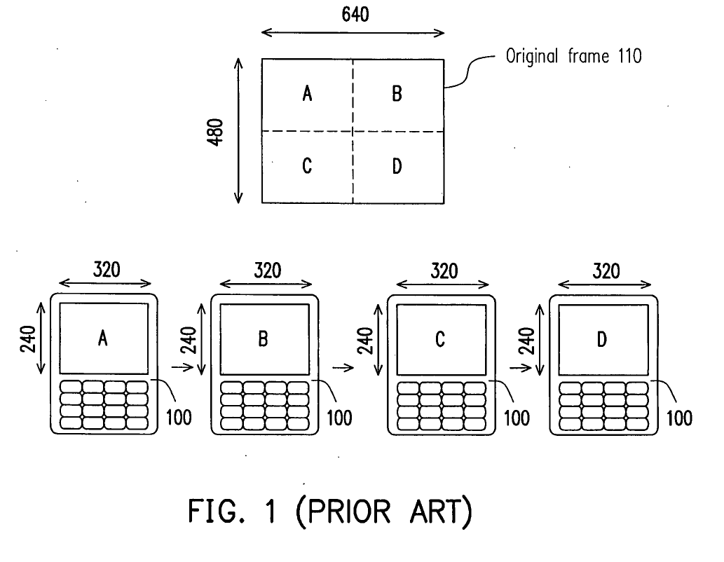

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

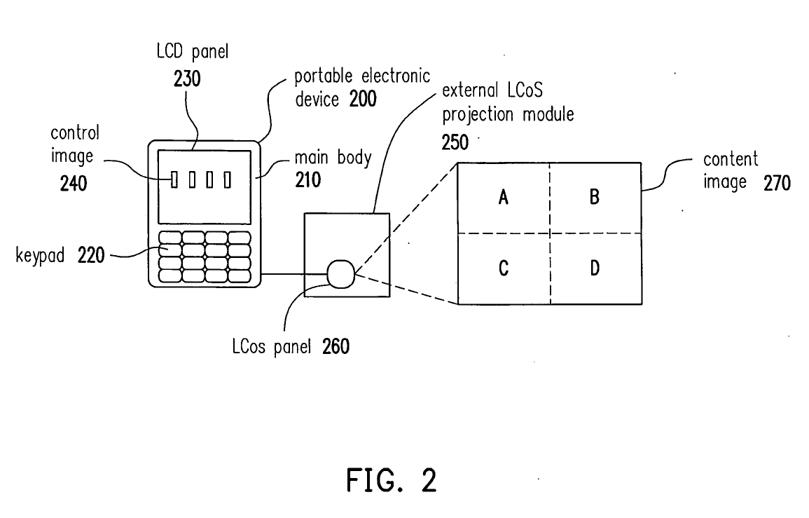

FIG. 2 shows a diagram of a portable electronic device according to a first embodiment of the invention. As shown in FIG. 2, the portable electronic device 200 according to a first embodiment of the invention includes a main body 210, a keypad 220, a display panel 230 and an external LCoS (liquid crystal on silicon) projection module 250. The external LCoS projection module 250 at least includes a high resolution LCoS panel 260 and other necessary components (not shown). The display panel 230 is for example, a LCD (liquid crystal display) panel.

### First Example of First Embodiment

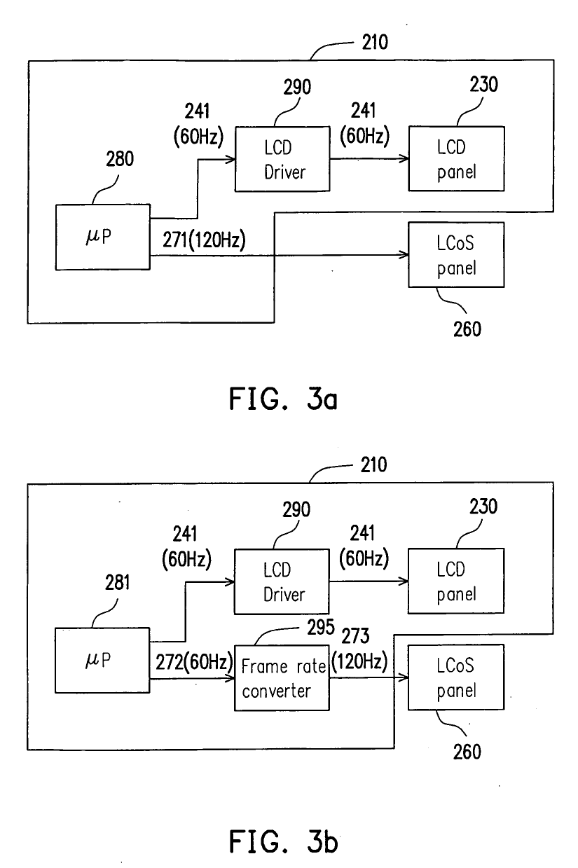

FIG. 3a shows a simplified block diagram of the portable electronic device 200 according to a first example of the first embodiment of the invention. Now please refer to FIG. 2 and FIG. 3a.

As shown in FIG. 3a, the portable electronic device 200 according to the first example of the first embodiment of the invention further includes a microprocessor 280 and a driver 290. The LCoS panel is disposed outside the main body 210 of the portable electronic device 200.

The main body 210 is used for supporting components, such as the keypad 220, the LCD panel 230, the microprocessor 280 and the driver 290.

The microprocessor 280 is mounted in the main body 210. The microprocessor 280 is used for sending out the control image signal 241 of for example 60 Hz and the content image signal 271 of 120 Hz. The microprocessor 280 is for example, a CPU (central processor unit) or a DSP (digital signal processor). The control image signal 241 is for displaying control options for selection and the content image signal 271 is generated according to a selected one of the control options.

The LCD driver 290 is also mounted in the main body 210. The LCD driver 290 is used for receiving the control image signal 241 from the microprocessor 280 to drive the LCD panel 230.

The LCD panel 230 is built in the main body 210. The LCD panel 230 receives outputs (the control image signal 241) from the LCD driver 290 and displays as the control image 240 at full screen. The LCD panel 230 is for displaying the control image 240 with control options according to the control image signal 241.

The content image signal 271 from the microprocessor 280 is output to the LCoS panel 260 of the external projection module 250. The LCoS panel 260 receives the content image signal 271 and displays as the content image 270 at full screen.

When user browses internet web sites via the portable electronic device 200, the control image 240 includes for example, horizontal scroll image signal and/or vertical scroll image and the content image 270 is for example the website homepage. Further, the content image 270 and the control image 240 may have different refresh rates. For example, the content image 270 have higher refresh rate than the control image 240.

The external LCoS projection module 250 is independent of the LCD panel 230. The external LCoS projection module 250 is for projecting the content image 270 according to the content image signal 271, wherein display of the content image 270 is controlled by the control image 240 (with control options) displayed on the LCD panel 230.

The portable electronic device 200 is for example but not limited to a cellular phone, a PDA, a NB, an I-POD, a MP3 player, or a digital photo frame. Second example of the first embodiment

FIG. 3b shows a simplified block diagram of the portable electronic device 200 according to a second example of the first embodiment of the invention. Now please refer to FIG. 2 and FIG. 3b.

As shown in FIG. 3b, the portable electronic device 200 according to the second example of the first embodiment of the invention further includes a microprocessor 281, a frame rate converter 295 and a driver 290. The LCoS panel is disposed outside the main body 210 of the portable electronic device 200.

In this example, the microprocessor 281 is used for sending out the control image signal 241 of for example 60 Hz and the content image signal 272 of 60 Hz. The microprocessor 281 is for example, a CPU (central processor unit) or a DSP (digital signal processor). The control image signal 241 is for displaying control options for selection and the content image signal 272 is generated according to a selected one of the control options.

In the second example, the LCD driver 290 and the LCD panel 230 is similar or the same with those in the first example.

The content image signal 272 (of 60 Hz) from the microprocessor 281 is input to the frame rate converter 295. The frame rate converter 295 converts the content image signal 272 of 60 Hz into a content image signal 273 of 120 Hz.

The LCoS panel 260 receives the content image signal 273 of 120 Hz from the frame rate converter 295 and displays as the content image 270 at full screen.

The external LCoS projection module 250 in the second example is the same or similar with that in the first example.

In the summary, the microprocessor 280 in the first example, which is capable of sending the control image signal 241 and the content image signal 271 with different frequencies, is more powerful than the microprocessor 281 in the second example, which only sends the control image signal 241 and the content image signal 272 of the same different frequency (both 60 Hz). Therefore, in the second example, the frame rate converter 295 is needed to double frequency of the content image signal 272. This is because the LCoS panel 260 is capable of receiving signal of 120 Hz for frame inversion display.

Further, in the first example of the first embodiment, because the microprocessor 280 is capable of sending signals of 60 Hz and signals of 120 Hz, a frame rate converter or means for converting frame rate may be regarded as being integrated into the microprocessor 280.

### Second Embodiment

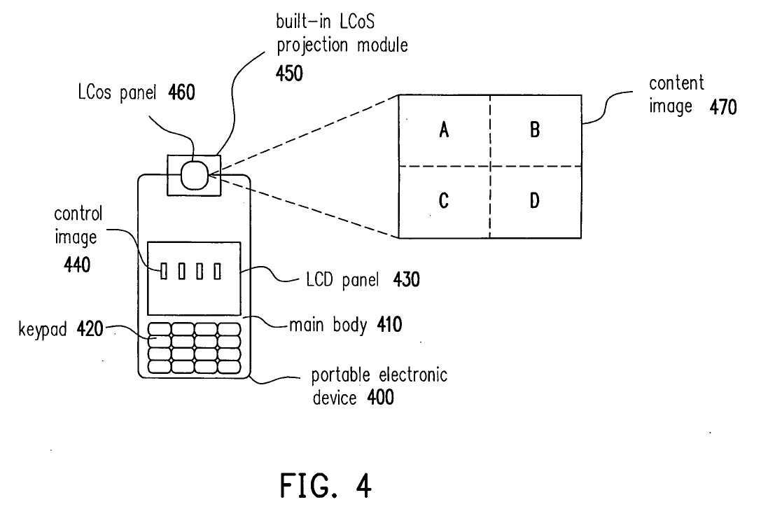

FIG. 4 shows a diagram of a portable electronic device according to a second embodiment of the invention. As shown in FIG. 4, the portable electronic device 400 according to the second embodiment of the invention includes a main body 410, a keypad 420, a display panel 430 and a built-in LCoS projection module 450. The built-in LCoS projection module 450 at least includes a high resolution LCoS panel 460 and other necessary components (not shown). The display panel 430 is for example, a LCD panel.

### First Example of the Second Embodiment

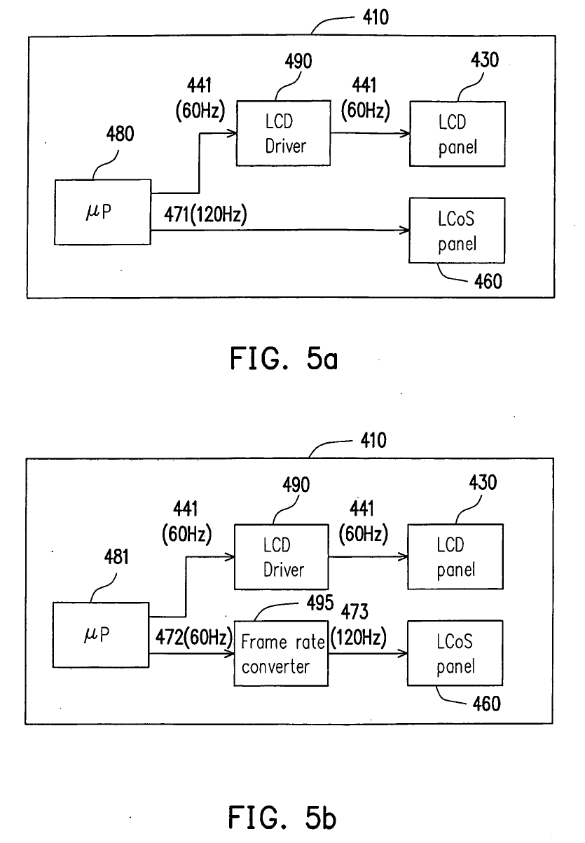

FIG. 5a shows a simplified block diagram of the portable electronic device 400 according to a first example of the second embodiment of the invention. Now please refer to FIG. 4 and FIG. 5a.

As shown in FIG. 5a, the portable electronic device 400 according to the first example of the second embodiment of the invention further includes a microprocessor 480 and a driver 490. The LCoS panel 460 is disposed inside the main body 410 of the portable electronic device 400.

The main body 410 is used for supporting components, such as the keypad 420, the LCD panel 430, the LCoS panel 460, the microprocessor 480 and the driver 490.

The microprocessor 480 is mounted in the main body 410. The microprocessor 480 is used for sending out the control image signal 441 of for example 60 Hz and the content image signal 471 of 120 Hz. The microprocessor 480 is for example, a CPU (central processor unit) or a DSP (digital signal processor). The control image signal 441 is for displaying control options for selection and the content image signal 471 is generated according to a selected one of the control options.

The LCD driver 490 is also mounted in the main body 410. The LCD driver 490 is used for receiving the control image signal 441 from the microprocessor 480 to drive the LCD panel 430.

The LCD panel 430 is built in the main body 410. The LCD panel 430 receives outputs (the control image signal 441) from the LCD driver 490 and displays as the control image 440 at full screen. The LCD panel 430 is for displaying the control image 440 with control options according to the control image signal 441.

The content image signal 471 from the microprocessor 480 is output to the LCoS panel 460 of the built-in LCoS projection module 450. The LCoS panel 460 receives the content image signal 471 and displays as the content image 470 at full screen.

When user browses internet web sites via the portable electronic device 400, the control image 440 includes. for example, horizontal scroll image signal and/or vertical scroll image and the content image 470 is for example the website homepage. Further, the content image 470 and the control image 440 may have different refresh rates. For example, the content image 470 have higher refresh rate than the control image 440.

The built-in LCoS projection module 450 is independent of the LCD panel 430, although they both are inside the main body 410. The built-in LCoS projection module 450 is for projecting the content image 470 according to the content image signal 471, wherein display of the content image 470 is controlled by the control image 440 (with control options) displayed on the LCD panel 430.

The portable electronic device 400 is for example but not limited to a cellular phone, a PDA, a NB, an I-POD, a MP3 player, or a digital photo frame. Second example of the second embodiment

FIG. 5b shows a simplified block diagram of the portable electronic device 400 according to a second example of the second embodiment of the invention. Now please refer to FIG. 4 and FIG. 5b.

As shown in FIG. 5b, the portable electronic device 500 according to the second example of the second embodiment of the invention further includes a microprocessor 481, a frame rate converter 495 and a driver 490. The LCoS panel 460 is disposed inside the main body 410 of the portable electronic device 400.

In this example, the microprocessor 481 is used for sending out the control image signal 441 of for example 60 Hz and the content image signal 472 of 60 Hz. The microprocessor 481 is for example, a CPU (central processor unit) or a DSP (digital signal processor). The control image signal 441 is for displaying control options for selection and the content image signal 472 is generated according to a selected one of the control options.

In the second example, the LCD driver 490 and the LCD panel 430 is similar or the same with those in the first example.

The content image signal 472 (of 60 Hz) from the microprocessor 481 is input to the frame rate converter 495. The frame rate converter 495 converts the content image signal 472 of 60 Hz into a content image signal 473 of 120 Hz.

The LCoS panel 460 receives the content image signal 473 of 120 Hz from the frame rate converter 495 and displays as the content image 470 at full screen.

The built-in LCoS projection module 450 in the second example is the same or similar with that in the first example.

In the summary, the microprocessor 480 in the first example, which is capable of sending the control image signal 441 and the content image signal 471 with different frequencies, is more powerful than the microprocessor 481 in the second example, which only sends the control image signal 441 and the content image signal 472 of the same different frequency (both 60 Hz). Therefore, in the second example, the frame rate converter 495 is needed to convert (for example, double) frequency of the content image signal 472. This is because the LCoS panel 460 is capable of receiving signal of 120 Hz for frame inversion display.

Further, in the first example of the second embodiment, because the microprocessor 480 is capable of sending signals of 60 Hz and signals of 120 Hz, a frame rate converter or means for converting frame rate may be regarded as being integrated into the microprocessor 480.

As stated above, in the embodiments of the invention, the control image is displayed on the LCD panel at full screen while the content image is displayed on the LCoS panel (either in external LCoS projection module or in built-in LCoS projection module) at full screen. So that, even when user view high resolution image, this high resolution image may be displayed on the high resolution LCoS panel while the control image for controlling display of the high resolution image may be displayed on the LCD panel.

Still further, according to the above embodiment of the invention, another embodiment of the invention further provides a display method for high resolution images, suitable in portable electronic devices. The display method includes: (A) providing a first video signal (for example the control image signals in the above embodiments) and a second video signal (the content image signals in the above embodiments), wherein the first video signal is for displaying control options for selection, and the second video signal is generated according to a selected one of the control options; (B) displaying a first image (the control images in the above embodiments) with the control options according to the first video signal; (C) converting the second video signal into a third video signal (signals 273 and 473 in the above embodiments); and (D) projecting the second image according to the third video signal, wherein the second image being controlled by the control options.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A portable electronic device, comprising:
a processor for providing a first video signal and a second video signal, wherein the first video signal is for displaying control options for selection, and the second video signal is generated according to a selected one of the control options;
a display panel for displaying a first image with the control options according to the first video signal;
a frame rate converter for converting the second video signal into a third video signal; and
a projector, independent of said display panel, for projecting a second image according to the third video signal, wherein the second image being controlled by the control options displayed on the display panel.

2. The portable electronic device of claim 1, wherein the first and the third video signals have different frequencies.

3. The portable electronic device of claim 1, wherein the first and the second images have different refresh rate.

4. The portable electronic device of claim 2, wherein the first image has a lower refresh rate than the second image.

5. The portable electronic device of claim 1, wherein the frame rate converter is integrated in the processor.

6. The portable electronic device of claim 1, wherein the frame rate converter is integrated in the projector.

7. The portable electronic device of claim 1, wherein the projector comprises an LCOS panel.

8. The portable electronic device of claim 7, wherein the LCOS panel is built in the portable electronic device.

9. The portable electronic device of claim 7, wherein the LCOS panel is an external module.

10. The portable electronic device of claim 1, wherein the display panel is an LCD panel.

11. The portable electronic device of claim 1, wherein the portable electronic device comprises a cellular phone, a PDA, a NB, an I-POD, a MP3 player.

12. A display method, comprising:
providing a first video signal and a second video signal, wherein the first video signal is for displaying control options for selection, and the second video signal is generated according to a selected one of the control options;
displaying a first image with the control options according to the first video signal;
converting the second video signal into a third video signal; and
projecting the second image according to the third video signal, wherein the second image being controlled by the control options.

13. The display method of claim 12, wherein the first and the third video signals have different frequencies.

14. The display method of claim 12, wherein the first and the second images have different refresh rate.

15. The display method of claim 14, wherein the first image has a lower refresh rate than the second image.
